(19) United States
(12) Patent Application Publication
(10) Pub. No.: US 2011/0025164 A1
(43) Pub. Date: Feb. 3, 2011

(54) ROTATING ELECTRIC MACHINE AND METHOD FOR MANUFACTURING STATOR

(76) Inventors: Yuichiro Tanaka, Ibaraki (JP); Takashi Ishigami, Ibaraki (JP); Takashi Naganawa, Ibaraki (JP); Hiromichi Hiramatsu, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/744,744

(22) PCT Filed: Nov. 27, 2008
(86) PCT No.: PCT/JP2008/071565

§ 371 Date: Oct. 21, 2010

(30) Foreign Application Priority Data
Nov. 27, 2007 (JP) 2007-305495

(51) Int. Cl. H02K 3/28; H02K 15/04

(52) U.S. Cl. 310/206; 29/596

(57) ABSTRACT

A rotating electric machine comprises a stator in which a stator winding is inserted in a plurality of slots extending in an axial direction in an inner circumference of a stator core, and a rotor that is rotatable in the stator. A plurality of the stator windings are constituted with continuously wound coils in which rectangular conductors are connected by cross-over conductors spanning over the plurality of slots, and end positions of the cross-over conductors vary in the circumferential direction of the stator.

### TECHNICAL FIELD

The present invention relates to a rotating electric machine including a stator winding formed by a continuously wound coil which is connected by cross-over conductors spanning a plurality of slots and a method for manufacturing a stator.

### BACKGROUND ART

Stator windings come in form of a concentrated winding in which coils are wound for each pole teeth in a concentrated manner and a distributed winding in which coils are wound spanning a plurality of slots so that coils with different phase or the same phase overlap at the coil ends. A stator of the concentrated winding has a small coil end and thus it is effective to downsize the rotating electric machine and improve the efficiency thereof. However, since a rotating magnetic field generated in the inner circumference of the stator is not uniformly distributed, it has a disadvantage such as noise generated when rotating attributed to, in particular, 5th and 7th harmonic components. On the other hand, a stator of the distributed winding has a rotating magnetic field of the stator inner circumference close to a sine wave, and thus noise generated when rotating can be reduced more than that of the concentrated winding. However, since the distributed winding has many coils overlapping at the coil ends, it gets more bulky than a concentrated winding, thereby having issues in downsize and high efficiency remaining.

In addition, a high-output, low-voltage motor driven by a battery is required to be downsized and high-output in very high level. One of the means to achieve such a requirement is to increase the coil space factor in a stator slot by using a copper wire with a rectangular cross section for the coil. For example, patent reference literature 1, patent reference literature 2, and the like disclose technology that increases a coil space factor by constituting a stator coil of a concentrated winding with a wire with a rectangular cross section. Such an application of a wire with a rectangular cross section to a concentrated winding can be achieved relatively easily because of a simple coil form.

In addition, in the event that a wire with a rectangular cross section is applied to the stator coil of the distributed winding, it is required to avoid conduction interference between wires while retaining the alignment of each of the wires. Three-phase coils with concentric winding are used as a means to avoid conduction interference between wires (refer to, for instance, patent reference literature 3). In this case, the coil ends of the three-phase coils are configured by layering wires of each of U phase, V phase, and W phase in an axial direction and by assembling them so that the coil ends of each phase do not overlap, thereby avoiding conduction interference between different coils.

[Patent Reference Literature 1] Japanese Laid Open Patent Publication No. 2004-80860 (refer to paragraphs 0021 to 0027 and FIG. 1 to FIG. 4)
[Patent Reference Literature 2] Japanese Laid Open Patent Publication No. 2006-288123 (refer to paragraphs 0014 to 0021 and FIG. 1 to FIG. 5)
[Patent Reference Literature 3] Japanese Laid Open Patent Publication No. 2006-101654 (refer to paragraphs 0016 to 0039 and FIG. 1 to FIG. 3)

### DISCLOSURE OF THE INVENTION

### Problems to be Solved by the Invention

However, since the coil end of each phase is deformed and built into the stator coil of the distributed winding disclosed in patent reference literature 3 so as to prevent wires formed by layering in the coil end from conduction interference, the coil end becomes larger in size.

In the light of the above circumstances, the present invention intends to provide a downsized rotating electric machine by reducing a coil end in size and a method for manufacturing a stator.

### Means for Solving the Problems

In order to solve the problem, the coil of the rotating electric machine of the present invention is configured with a rectangular conductor having an insulating coating so as to increase the space factor of the conductor in the slot, thereby achieving a high output. In addition, downsize of the rotating electric machine is achieved by constituting with a continuously wound coil, overlapping the coil ends of each coil in the circumferential direction, and reducing the coil ends of the both ends of the stator core. In addition, the coils are connected by the cross-over conductor so as to constitute the continuously wound coil, thereby reducing the number of connections at conductor terminals and achieving low cost.

### ADVANTAGEOUS EFFECT OF THE INVENTION

According to the present invention, the coil end can be reduced in size. This enables the rotating electric machine to be high-output, downsized, and low-cost.

### BRIEF DESCRIPTION OF THE DRAWINGS

FIG. 1 An exploded perspective view showing the structure of the rotating electric machine of an embodiment of the present invention.

FIG. 2 A flow diagram showing the flow of the process to form a continuously wound coil winding.

FIG. 3 A flow diagram showing the flow of the process to constitute an assembly coil using a plurality of continuously wound coil windings.

FIG. 4 An illustration of the assembly coil separated into six continuously wound coil windings.

FIG. 5 An illustration of a winding lead-in section, partly extracted from the exploded view of the continuously wound coil winding.

FIG. 6 An illustration of the assembly coil shaped into an annular assembly coil.

FIG. 7 Illustrations of the annular assembly coil and a stator core in which the annular assembly coil is built.

FIG. 8 An illustration of one coil of the annular assembly coil being bent and inserted into a slot of the stator core.

FIG. 9 A flowchart showing the process to provide the stator with a stator winding.

### EXPLANATION OF REFERENCE NUMERALS

1 coil wire
1-1 to 1-8 first coil to eighth coil
2a, 2b bent portion
3 cross-over conductor
4 winding frame
5, 6 conductor terminal
7 cutter blade
8 continuously wound coil winding
9 pressing machine
10 assembly coil
11 to 16 first continuously wound coil winding to sixth continuously wound coil winding
11a to 16a, 11b to 16b removal positions of cross-over conductors
(11A to 16A) to (11H to 16H) winding lead-in section
20 annular assembly coil
21 stator core
21a slot
22 coil
23 honeycomb coil
24 insulating paper
30 rotating electric machine
31 stator
34 stator winding
41 rotor
42 rotor core
44 permanent magnet

### BEST MODE FOR CARRYING OUT THE INVENTION

An embodiment of shaping method of the distributed winding stator to achieve the rotating electric machine of the present invention will now be explained in detail with reference to the drawings.

### First Embodiment

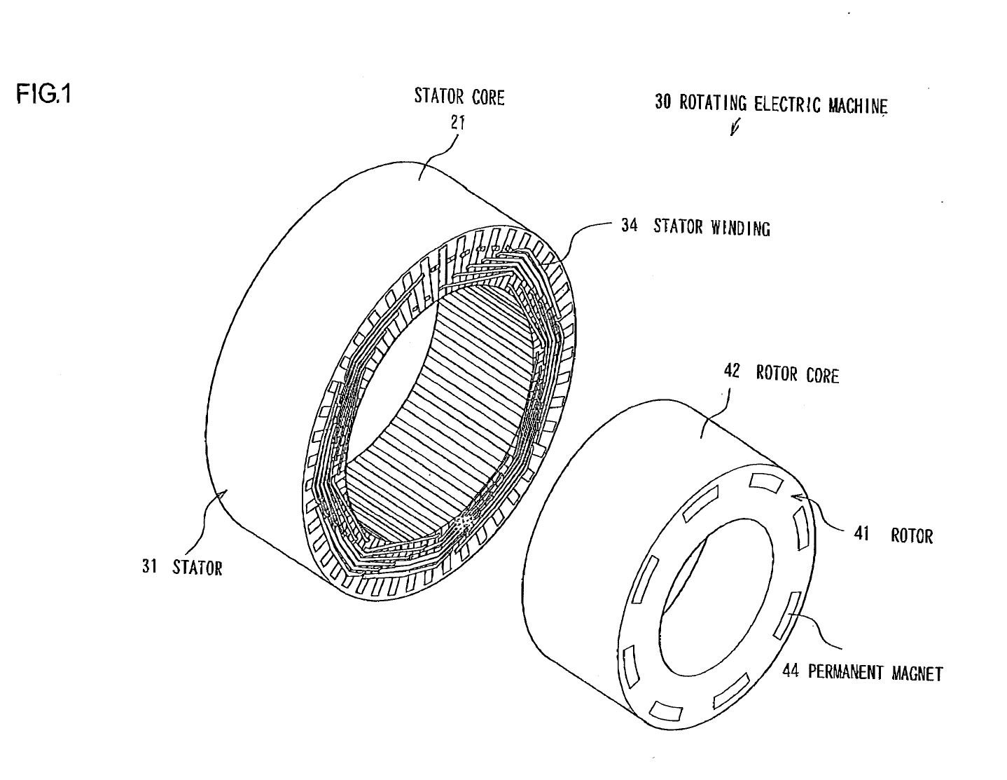

FIG. 1 is an exploded perspective view of the rotating electric machine of an embodiment of the present invention. As shown in FIG. 1, a rotating electric machine 30 according to the present embodiment includes a stator 31 and a rotor 41, which is disposed on the inner circumference side of the stator 31 through a gap and rotatably supported. Although the stator 31 and the rotor 41 are actually held in a housing of the rotating electric machine 30, the housing and the formation of a honeycomb coil 23 (FIG. 8) are not illustrated in the figure.

The stator 31 includes a stator core 21 and a stator winding 34. In order to reduce eddy-current loss, the stator core 21 is constituted with thin magnetic steel sheets press-formed into a predetermined shape and laminated in an axial direction. A plurality of slots continuous in an axial direction are formed in the inner circumference of the stator core 21. It is to be noted that 48 slots are formed in the present embodiment. The stator winding 34 is wound on the stator core 21 in distributed winding. Here, a distributed winding is a winding method in which a coil is wound on the stator core 21 so as to be stored in two slots that are spaced over the plurality of slots.

The rotor 41 includes a rotor core 42 and a permanent magnet 44. The rotor core 42 is constituted with thin magnetic steel sheets press-formed into a predetermined shape and laminated. A plurality of magnet insertion holes penetrating in an axial direction of the rotor 41 are formed at regular intervals in the circumferential direction in the outer circumference of the rotor core 42. In the present embodiment, eight magnet insertion holes are formed. The permanent magnet 44 is applied to each of the permanent magnet insertion holes so as to alternate in polarity. It is to be noted that the core formed between the permanent magnets 44 serves as an auxiliary magnetic pole.

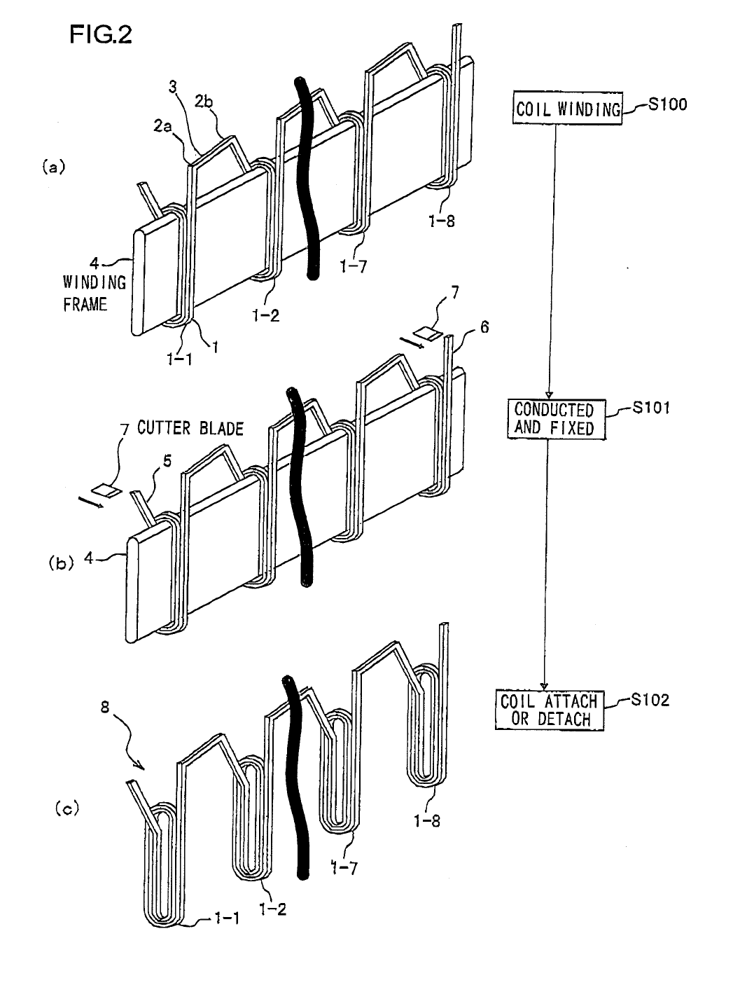

FIG. 2 is a flow diagram showing the flow of the process to form a continuously wound coil winding 8 (FIG. 2(c)), which is a component constituting the stator winding. As shown in FIG. 2(a), at first, a coil wire 1 of a rectangular conductor is wound on a winding frame 4 a plurality of times and laminated so as to form a first coil 1-1. Then, a conductor terminal of the end of the first coil 1-1 is bent in the direction in which the width of the rectangular conductor is narrow so as to form a bent portion 2a. It is to be noted that, for example, the narrower width of the rectangular conductor of the coil wire 1 is 0.6 mm while the broader width thereof is 3.6 mm.

In addition, a cross-over conductor 3 is led directly from the bent portion 2a in parallel with the end face of the winding frame 4 and bent in the same manner in the direction in which the width of the rectangular conductor is narrow so as to form a bent portion 2b. Then, the coil wire 1 is led from the bent portion and wound on the winding frame 4 in the same direction so as to form a second coil 1-2. In the same manner the total of eight coils (from the first coil 1-1 to the eighth coil 1-8) are formed and the preparation of the coil winding is completed (step S100). It is to be noted that the cross-over conductor 3 is a conductor portion that couples coils including the bent portion 2a and the bent portion 2b.

Next, as shown in FIG. 2(b), a cutter blade 7 is put against each of a conductor terminal 5 and a conductor terminal 6 constituted with two rectangular conductors formed by the coil wire 1 so that the cutter blade 7 penetrates the insulating coating of the coil wire 1 and leads to the conductor portion of the coil wire 1. Although not illustrated in FIG. 2, since a coil electric conduction heating device is connected to the cutter blade 7, current is applied to the cutter blade 7 so as to fuse a self-welding layer on the surface of the coil wire 1 and causes the coil wires 1 bonded together. (step S101).

In addition, as shown in FIG. 2(c), the winding frame 4 is removed from the formed coil wire 1, and the continuously wound coil winding 8, constituted with the first coil 1-1 to the eighth coil 1-8, is thus formed (step S102).

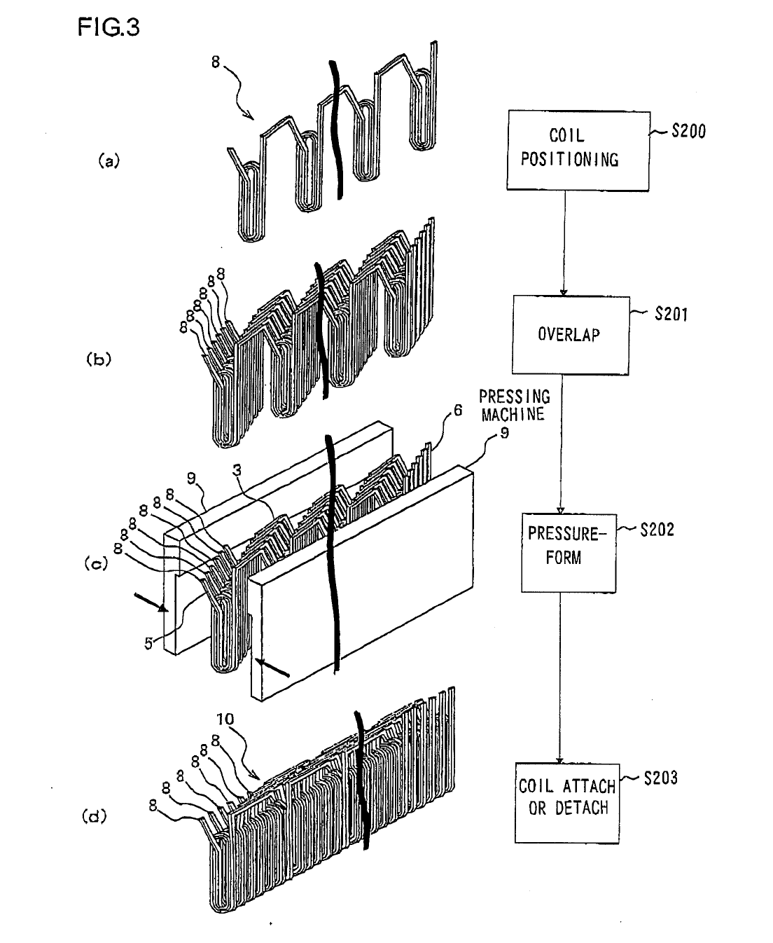

FIG. 3 is a flow diagram showing the flow of the process to constitute the assembly coil 10 using a plurality of the continuously wound coil windings 8 formed by the process of FIG. 2. At first, as shown in FIG. 3(a), the continuously wound coil winding 8 assembled in the process of FIG. 2 is positioned and fixed on an assembly machine (not shown in the figure) (step S200). Next, as shown in FIG. 3(b), the second continuously wound coil winding 8 (i.e., the second farthest continuously wound coil winding 8 in FIG. 3 (b)) is overlapped with the first continuously wound coil winding 8 (i.e., the farthest continuously wound coil winding 8 in FIG. 3(b)) at pitch intervals corresponding to slot intervals of the stator core 21 (FIG. 8). In the same manner, the six continuously wound coil windings 8 are overlapped in total (step S201).

Next, as shown in FIG. 3(c), the six overlapped continuously wound coil windings 8 are pressure-formed by a pressing machine 9 (step S202). By doing this, the cross-over conductor 3, which connects coils, and the conductor terminals 5 and 6 are all arranged on the coil end, and the continuously wound coil windings 8 can be aligned. Next, as shown in FIG. 3(d), the pressing machine 9 is cleared, so that the six continuously wound coil windings 8 are twisted in a direction of plastic deformation and thus the aligned assembly coil 10 can be obtained (step S203).

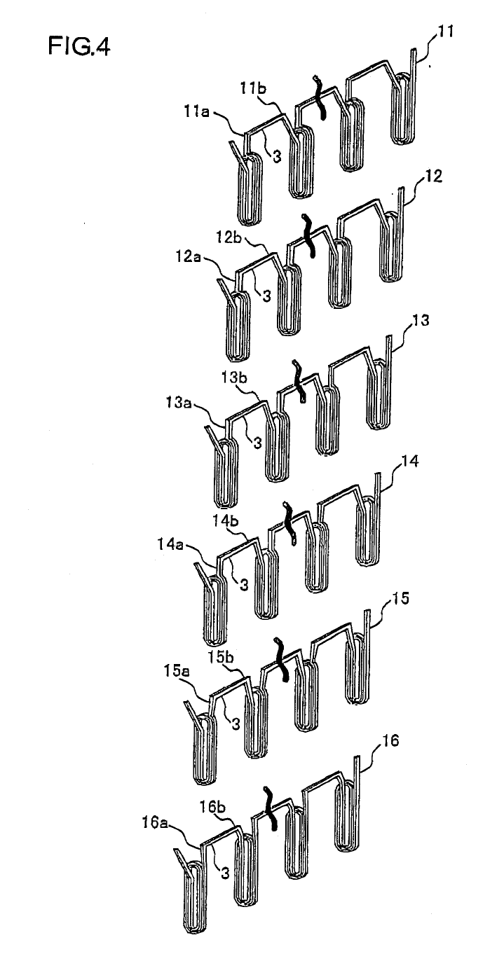

FIG. 4 is an illustration of the assembly coil 10 formed in the process of FIG. 3 being separated into the six continuously wound coil windings 8. In the illustration of the state of separation of FIG. 4, a first continuously wound coil winding 11 is the coil winding located in the assembly coil 10 on the extreme right of the figure. The first continuously wound coil winding 11 has a removal position 11a of the cross-over conductor 3, plastically deformed in the farthest of the assembly coil 10 of FIG. 3 with respect to the initial shape of the continuously wound coil winding 8 shown in FIG. 3(a), whilst the other removal position 11b of the cross-over conductor 3 maintains the initial shape of the continuously wound coil winding 8 shown in FIG. 3(a).

Next, with respect to the initial shape of the continuously wound coil winding 8 shown in FIG. 3(a), a second continuously wound coil winding 12, which is the second from right, in the assembly coil 10 of FIG. 4, has a removal position 12a of the cross-over conductor 3, plastically deformed slightly in front (nearer to the viewer of the figure), compared to the removal position 11a. On the other hand, a removal position 12b of the cross-over conductor 3 is plastically deformed slightly in front (nearer to the viewer of the figure), compared to the removal position 11b.

Next, the removal position of the cross-over conductor 3 of each of a third continuously wound coil winding 13, which is the third from right, a fourth continuously wound coil winding 14, which is the fourth from right, a fifth continuously wound coil winding 15, which is the fifth from right, and a sixth continuously wound coil winding 16, which is the sixth from right, in the assembly coil 10 of FIG. 4 is plastically deformed slightly in front (nearer to the viewer of the figure) in sequence. In this manner, removal positions 13a, 14a, 15a, and 16a of the cross-over conductor 3 and removal positions 13b, 14b, 15b, and 16b of the cross-over conductor 3 each vary gradually slightly in front (nearer to the viewer of the figure), and a removal position 16a of the cross-over conductor 3 maintains the initial shape. Therefore, the assembly coil 10, in which these six continuously wound coil windings 11 to 16 are assembled, has the removal positions of the cross-over conductors 3 misaligned by the broader conductor width of the rectangular conductor with respect to the alignment direction of the continuously wound coil windings 11 to 16 so that the removal positions vary in a regular manner.

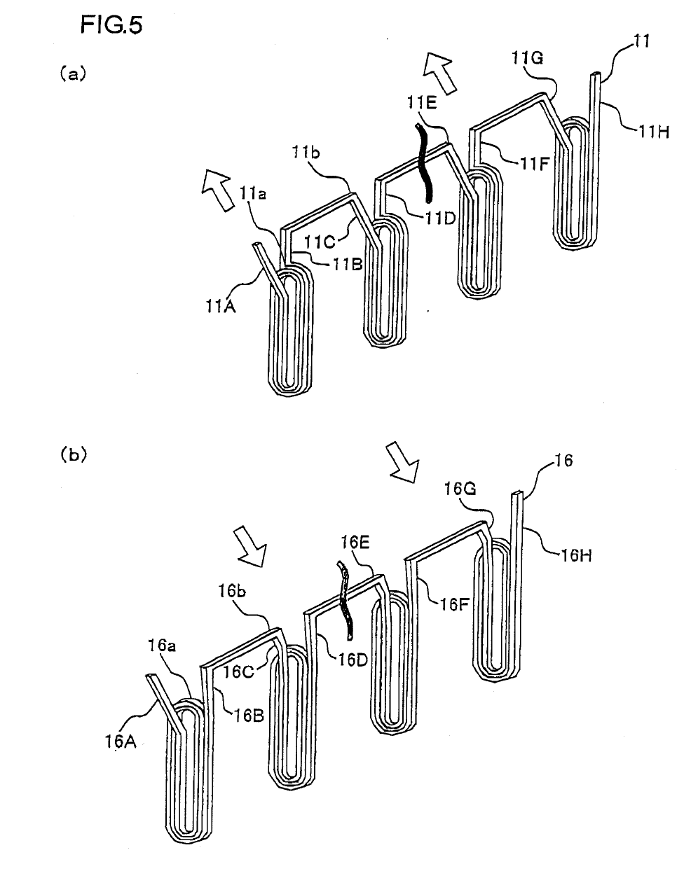

FIG. 5 is an illustration of a winding lead-in section, partly extracted from the exploded view of the continuously wound coil winding 8 in FIG. 4. More specifically, FIG. 5 shows winding lead-in sections of the first continuously wound coil winding 11 located on the extreme right of the assembly coil 10 of FIG. 4 and the sixth continuously wound coil winding 16 located on the extreme left thereof.

FIG. 5 is magnified views of the first continuously wound coil winding 11 on the extreme right of the assembly coil 10 and the sixth continuously wound coil winding 16 on the extreme left thereof. In FIG. 5(a), the first continuously wound coil winding 11 has a fixed winding lead-in section 11C and a winding lead-in section 11B that is plastically deformed most significantly in the direction of the arrow of the figure. In the same manner, a winding lead-in section 11H is fixed and a winding lead-in section 11F is plastically deformed slightly in the direction of the arrow of the figure. It is to be noted that the winding lead-in sections 11B and 11D are misaligned by the width direction of the rectangular conductor, and winding lead-in sections 11E and 11G are misaligned by the width direction of the rectangular conductor.

On the other hand, in FIG. 5(b) the sixth continuously wound coil winding 16 has a fixed winding lead-in section 16F and a winding lead-in section 160 that is plastically deformed in the direction of the arrow of the figure. In the same manner, a winding lead-in section 16B is fixed and a winding lead-in section 16C is plastically deformed in the direction of the arrow of the figure. As a result, the cross-over conductor 3 is twisted.

Hereinafter, the second continuously wound coil winding 12, the third continuously wound coil winding 13, the fourth continuously wound coil winding 14, and the fifth continuously wound coil winding 15, all of which lie between the first continuously wound coil winding 11, which is on the extreme right, and the sixth continuously wound coil winding 16, which is on the extreme left, each have plastic deformation to a certain extent between that of the first continuously wound coil winding 11 and that of the sixth continuously wound coil winding 16. Due to such plastic deformation, therefore, the removal positions of the cross-over conductor 3 can be arranged to vary in a regular manner with respect to the alignment direction of the continuously wound coil windings 11 to 16, in the assembly coil 10, in which the six continuously wound coil windings 11 to 16 are assembled.

It is to be noted that although in the present embodiment the rotating electric machine with forward wound coils, eight continuous coils, and the total of 48 coils has been explained, it is not limited thereto. The coils may be wound in a winding, and the number of continuous coils and the total number of the coils may be increased or decreased.

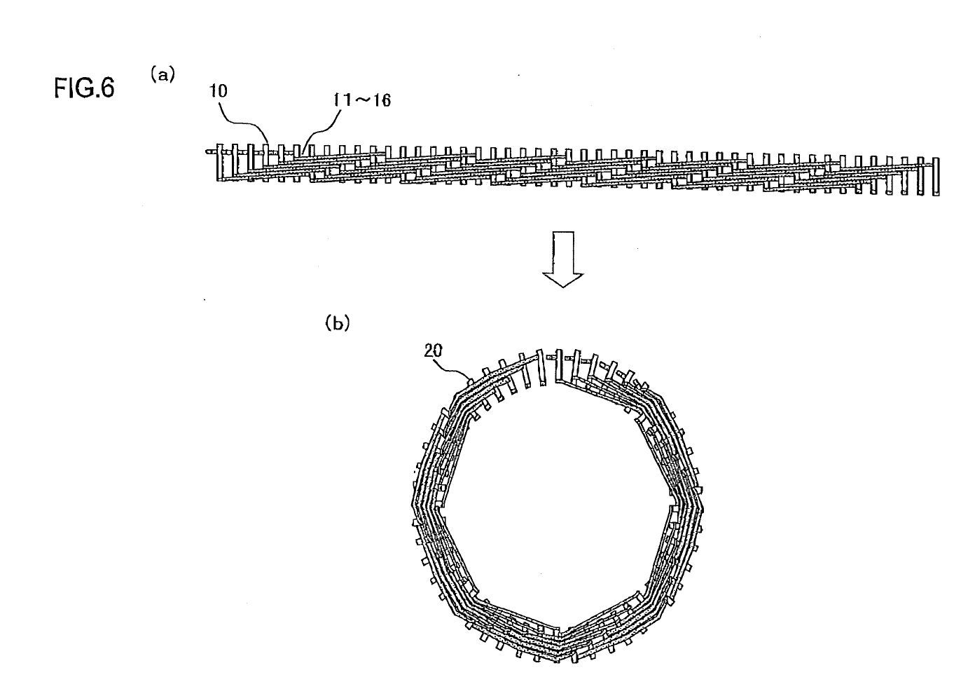

FIG. 6 is an illustration of the assembly coil 10 having been formed in the process of FIG. 3 and being shaped into an annular assembly coil 20. More specifically, FIG. 6(a) is a plan view of the assembly coil 10 in which the continuously wound coil windings 11 to 16 assembled in the process of FIG. 3 are viewed from an axial direction. This figure shows a state in which each of the continuously wound coil windings 11 to 16 are aligned, and, although not shown in the figure, an insulating paper 24 (FIG. 8) is already built in. The assembly coil 10 comes in form of a lap winding, in which a plurality of coil wires inserted into the adjacent slots are overlapped. It is to be noted that the cross-over conductor 3 is displaced with respect to an axial direction by the width of the rectangular conductor on one end and slightly inclining. More specifically, 118 in FIG. 5(a) is pulled inward by the conductor width of the rectangular conductor, compared with 11C, and 11F is pulled inward by the same conductor width, compared with 11G. In the same manner, 16C in FIG. 5(b) is pulled inward by the conductor width of the rectangular conductor, compared with 16B, and 16G is pulled inward by the same conductor width, compared with 16F. In addition, FIG. 6(b) exhibits the annular assembly coil 20, into which the assembly coil 10 of FIG. 6(a) is annularly shaped. In other words, as shown in FIG. 6(b), the assembly coil 10 is spirally formed into the annular assembly coil 20.

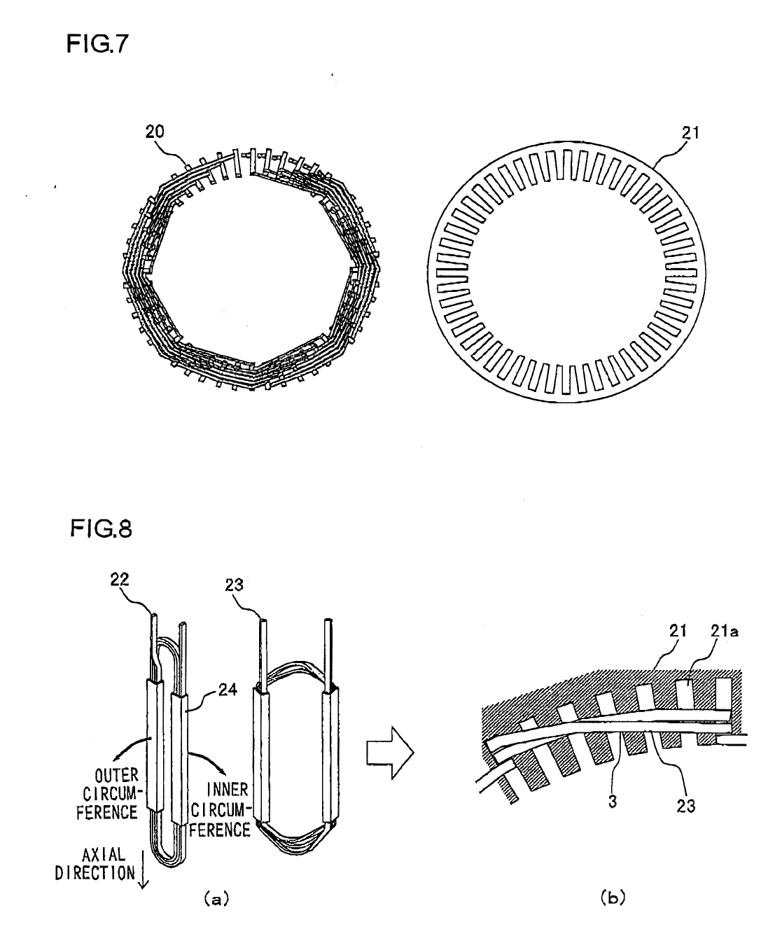

FIG. 7 is illustrations of the annular assembly coil 20 formed in FIG. 6 and the stator core 21 in which the annular assembly coil 20 is built. It is to be noted that in FIG. 7 the stator core 21 is formed with 48 slots. In order to wind the annular assembly coil 20 on the stator core 21 as a distributed winding, it is necessary to cause each coil of the annular assembly coil 20 to be deformed into honeycomb and inserted spanning the slots.

FIG. 8 is an illustration of one coil of the annular assembly coil 20 of FIG. 6 being bent and inserted into the stator core 21. More specifically, FIG. 8 is a conceptual diagram showing a state in which each coil of the annular assembly coil 20 of FIG. 6 is deformed into honeycomb and the coil is inserted into slots 21a of the stator core 21, in which FIG. 8(a) shows a state in which a coil 22 is deformed into a honeycomb coil 23 and FIG. 8(b) shows a state in which the honeycomb coil 23 is inserted into the slots 21a of the stator core 21. As shown in FIG. 8(a), the coil 22 is representative of coils in the annular assembly coil 20. The insulating paper 24 is wound on the coil 22. The conductor of the coil 22 located on the outer circumference side of the stator core 21 is bent to the left and the conductor of the coil 22 located on the inner circumference side thereof is bent to the right so as to form the honeycomb coil 23 as shown in the figure.

When the honeycomb coil 23, formed in this manner, is inserted into the slots 21a of the stator core 21, the position relationship of the conductors in each of the slots 21a becomes, as in FIG. 6(b), a distributed winding spanning a plurality of (five) slots. In addition, it is wound clockwise from the outer circumference side to the inner circumference side. Moreover, the adjacent continuously wound coil winding 8 is inserted into the adjacent slot and thus the lap winding is achieved. In this case, bending operations of the coil 22 are collectively performed for all the coils. Therefore, while the cross-over conductors 3 on the coil end remain overlapped in the circumferential direction of the stator core 21, the position relationship thereof can be maintained, thereby reducing the axial length of the coil end.

It is to be noted that while in the present embodiment the coil 22 has the conductor located on the outer circumference side of the stator core 21 to be bent to the left side and the conductor located on the inner circumference side thereof to be bent to the right side, it may be wound counterclockwise by bending the conductor located on the outer circumference side of the stator core 21 to the right side and bending the conductor located on the inner circumference to the left side to build in to the stator core 21. Also in this case, the stator of the motor can be realized with a coil end reduced in size.

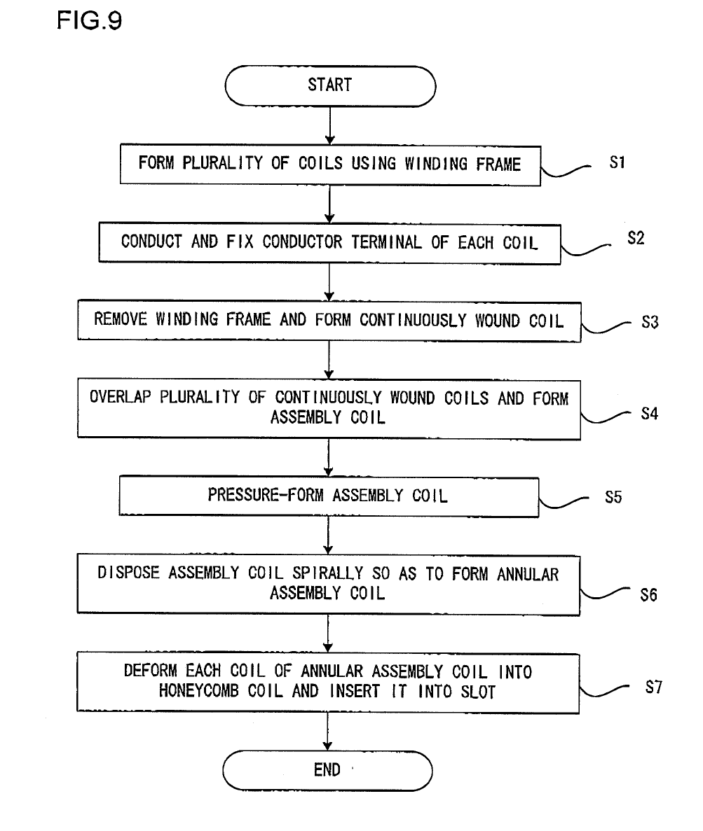

FIG. 9 is a flowchart showing the process to provide the stator core 21 with the stator winding in the first embodiment of the present invention. More specifically, in the method for manufacturing the rotating electric machine including the rotor 41 and the stator having the stator winding in the plurality of slots extending in the axial direction in the inner circumference of the stator core 21, at first, a plurality of coil wires of the rectangular conductor are wound on the winding frame 4 for the plurality of times. In other words, the plurality of coils (continuously wound coil windings) connected through the cross-over conductor 3 are formed by using the winding frame 4 (step S1).

Next, current is applied to the conductor terminal of the coil winding. As a result, the coil wires 1 are conducted and fixed (step S2). After that, the winding frame 4 is removed so as to form the plurality of coils as a continuously wound coil (step S3). The plurality of continuously wound coils formed in this manner are overlapped at pitch intervals corresponding to slot intervals so as to be pressure-formed. As a result, the plurality of continuously wound coils are overlapped and the assembly coil 10 is formed (step S4). Next, the sides of the assembly coil 10 are pressurized by the pressing machine 9 so as to be pressure-formed (step S5). Next, the pressurized assembly coil 10 is spirally formed into the annular assembly coil 20 (step S6). Then, each of the coils 22 of the annular assembly coil is deformed into the honeycomb coil 23 so as to be inserted into the slot 21a of the stator core 21 (stator) (step S7). As a result, the length of the coil end in the direction of the rotation axis can be reduced, and thus axial vibration caused while the rotating electric machine 30 is rotating can be reduced. For this reason, even if the rotating electric machine 30 rotates at a high speed, the axial vibration is reduced and a stable operation can be assuring.

### Second Embodiment

In the first embodiment described above, the cross-over conductor 3 is bent in the direction in which the width of the rectangular conductor is narrow so as to form in advance the bent portion. This is effective to improve assemblability in the event that the vertical and horizontal widths of the rectangular conductor are different significantly. However, in the event that the rectangular conductor is a square or close thereto, the cross-over conductor 3 is not necessarily bent in the direction in which the width of the rectangular conductor is narrow. In the second embodiment, the bending shape of the rectangular conductor is not limited.

1. A rotating electric machine that comprises a stator in which a stator winding is inserted in a plurality of slots extending in an axial direction in an inner circumference of a stator core, and a rotor that is rotatable in the stator, wherein:
a plurality of the stator windings are constituted with continuously wound coils in which rectangular conductors are connected by cross-over conductors spanning over the plurality of slots, and end positions of the cross-over conductors vary in the circumferential direction of the stator.

2. A rotating electric machine according to claim 1, wherein:
a plurality of the cross-over conductors are in a substantially same shape, and overlapped and disposed in a circumferential direction of the stator at regular intervals.

3. A rotating electric machine according to claim 1, wherein:
the cross-over conductors are disposed substantially spirally.

4. A rotating electric machine according to claim 1, wherein:
the cross-over conductors are bent in a direction in which a width of the rectangular conductor is narrow.

5. A rotating electric machine according to claim 1, wherein:
a winding method of the stator windings is a lap winding; and
the end positions are displaced in a circumferential direction at intervals of the slots.

6. A method for manufacturing a stator in which a stator winding is inserted in a plurality of slots extending in an axial direction in an inner circumference of a stator core, comprising:
a first step for winding a coil wire of a rectangular conductor on a winding frame for a plurality of times, and forming a plurality of coil windings connected through a cross-over conductor;
a second step for conducting the coil wire at each conductor terminal of the plurality of coil windings to fix the coil wire;
a third step for removing the winding frame and forming a continuously wound coil from the plurality of coil windings;
a fourth step for overlapping a plurality of the continuously wound coils at pitch intervals corresponding to slot intervals and pressure-forming the overlapped continuously would coils into an assembly coil;
a fifth step for disposing substantially spirally the pressure-formed assembly coil so as to form an annular assembly coil; and
a sixth step for deforming each coil of the annular assembly coil into a honeycomb coil and inserting the deformed coil into a slot of the stator core.
